(19) United States
(12) Patent Application Publication
(10) Pub. No.: US 2026/0105151 A1
(43) Pub. Date: Apr. 16, 2026

(54) DATA ANOMALY DETERMINATION BASED ON OBJECT TYPE INFORMATION FOR BLOCK INPUT/OUTPUT OPERATIONS

(71) Applicant: HEWLETT PACKARD ENTERPRISE DEVELOPMENT LP, Spring, TX (US)

(72) Inventors: Gil Barash, Herzliya (IL); Tal Aloni, Herzliya (IL); Omer Uretzky, Herzliya (IL)

(21) Appl. No.: 18/916,314

(22) Filed: Oct. 15, 2024

(51) Int. Cl. G06F 21/56; G06F 21/55; G06F 21/64

(52) U.S. Cl. CPC G06F 21/568; G06F 21/554; G06F 21/64

(57) ABSTRACT

In some examples, a system identifies a first block input/output (I/O) operation relating to writing metadata for a data object, the metadata of the first block I/O operation comprising first object type information. The system generates, based on a header of a second block I/O operation relating to writing object content to a target data object, second object type information relating to an object type of the target data object. The system compares the first object type information in the metadata of the first block I/O operation to the second object type information. Based on the comparing, the system determines whether an anomaly relating to data has occurred.

### BACKGROUND

A ransomware attack involves encrypting data on a computer or on multiple computers connected over a network. In a ransomware attack, data can be encrypted using an encryption key, which renders the data inaccessible to users unless a ransom is paid to obtain the encryption key. A ransomware attack can be highly disruptive to enterprises, including businesses, government agencies, educational organizations, individuals, and so forth.

### BRIEF DESCRIPTION OF THE DRAWINGS

Some implementations of the present disclosure are described with respect to the following figures.

FIG. 1 is a block diagram of an arrangement including a computer system that has a replication controller to replicate write input/output (I/O) operations to a recovery storage system, in accordance with some examples.

FIG. 2 is a flow diagram of a process of detecting an attack, in accordance with some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A ransomware attack can be difficult to detect. By the time a user (e.g., an individual human user, an organization such as a business, a government, or an educational organization, or any other type of entity) becomes aware of the attack, most or all of the data may have been encrypted and thus inaccessible. An inability to detect a ransomware attack in real time may reduce a user's ability to recover from the attack.

In some cases, ransomware can encrypt an entire data object, where a “data object” can refer to any or some combination of the following: a file of a file system, an image, a video, an executable program code, or any other container of data. In other cases, ransomware can perform intermittent encryption of a data object, in which the ransomware partially encrypts selected portions of the data object but does not encrypt other portions of the data object. Although ransomware protection systems may be able to detect ransomware that encrypts entire data objects, such ransomware protection systems may not work against ransomware that applies intermittent encryption. An intermittent encryption attack refers to an encryption attack in which less than the entirety of a data object is encrypted. As a result, a ransomware attack may escape detection, and any partially encrypted (intermittently encrypted) data objects are lost since a user may not be able to recover original data from the partially encrypted data objects.

In accordance with some implementations of the present disclosure, an encryption attack detector is able to determine whether an encryption attack is occurring based on monitoring block input/output (I/O) operations (including object block I/O operations and metadata block I/O operations) that access individual data blocks in a storage system, and determining whether object type information in the metadata block I/O operations match object type information in the object block I/O operations that target data objects. The encryption attack detected can include an intermittent encryption attack that partially encrypts a portion of a data object, or a full encryption attack that fully encrypts an entire data object. A “block I/O operation” is an I/O operation performed with respect to a data block in the storage system. A “data block” is stored in a storage block of the storage system, where each storage block has a specified size. The content of a data object may be stored in multiple data blocks in the storage system. By detecting an encryption attack based on monitoring block I/O operations, intermittent encryption attacks can be detected since the encryption attack detector does not rely on analyzing an entire data object to determine whether an encryption has been applied.

In some examples of the present disclosure, the encryption attack detector identifies, in a stream of block I/O operations: (1) metadata block I/O operations that relating to writing metadata for data objects, and (2) object block I/O operations relating to writing object content to target data objects. The encryption attack detector generates, based on a header of an object block I/O operation, object type information representing an object type of a target data object. The encryption attack detector compares object type information in the metadata of a metadata block I/O operation to the generated object type information. Based on the comparing, the encryption attack detector determines whether an unauthorized encryption of data has occurred.

In other examples, other anomalies relating to data may be detected using techniques or mechanisms according to some examples of the present disclosure. As an example, an anomaly relating to data can result from an error performed by an entity (e.g., a human, a program, or a machine). For example, the entity may have named a file with an incorrect extension.

In the ensuing discussion, reference is made to examples where data objects are files of a file system. Techniques or mechanisms according to further examples can be applied with respect to other types of data objects, such as images, video objects, executable program code objects, or any other containers of data. Also reference is made to encryption attacks. Techniques or mechanisms according to some examples can be applied to detect other anomalies relating to data.

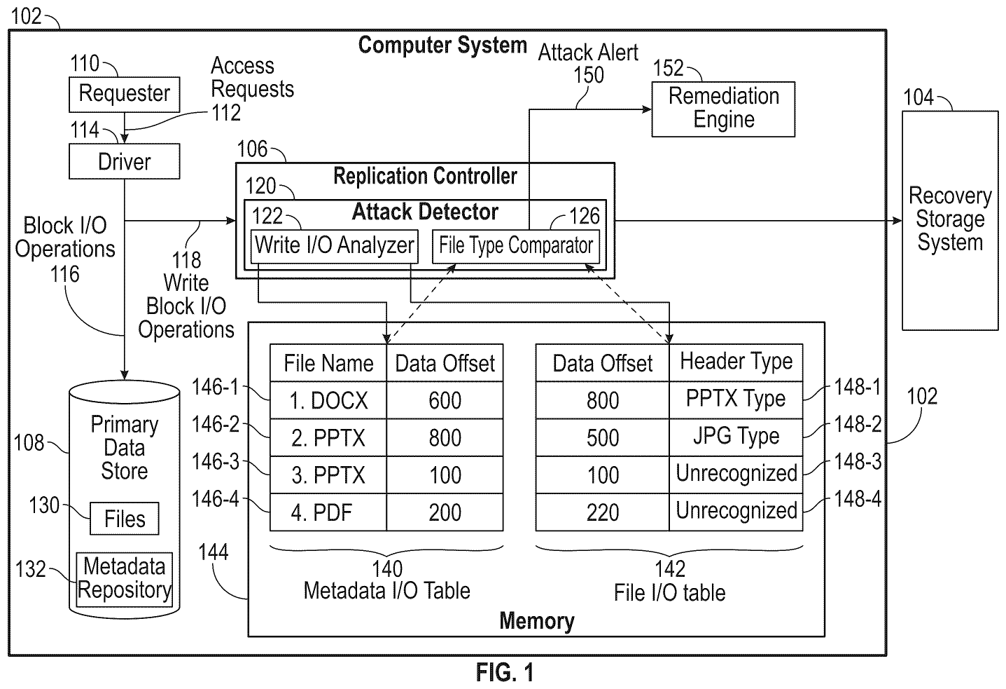

FIG. 1 is a block diagram of an example arrangement that includes a computer system 102 and a recovery storage system 104. The computer system 102 can include one or more computers.

The computer system 102 includes a replication controller 106 that replicates write I/O operations to the recovery storage system 104. In some examples, the write I/O operations are replicated to a journal stored in the recovery storage system 104. The journal includes entries to which write I/O operations are replicated by the replication controller 106. A “journal” can refer to a data structure that logs write I/O operations that modify data items, such as data blocks. A write I/O operation to a data block is referred to as a “write block I/O operation.”

A write block I/O operation can update data, add new data, or delete existing data in a data block. Replicating a write block I/O operation to an entry of the journal can refer to adding information representing the write block I/O operation to the entry of the journal. In response to an event, entries of the journal may be applied to a backup data store (not shown) that stores copies of a primary data store 108 of the computer system 102. An event that triggers the application of entries of the journal to the backup data store can include a time-based event (e.g., which can cause application of entries of the journal on a periodic basis) or any other type of event.

As used here, a “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” can refer to a combination of one or more hardware processing circuits and machine-readable instructions (software and/or firmware) executable on the one or more hardware processing circuits.

The primary data store 108 is a data store for storing data used in operations of a requester 110, such as when the requester 110 is executing workloads of application programs, an operating system (OS), or other programs. A “data store” can be implemented in a storage system.

The requester 110 can issue access requests 112 (read requests and write requests) to read data from the primary data store 108 or write data to the primary data store 108. An example of the requester 110 is a virtual compute entity, such as a virtual machine (VM) or a container. In other examples, the requester 110 can include a program or a hardware component. Although just one requester is shown in FIG. 1, in other examples, there may be multiple requesters that can access data of the primary data store 108.

The access requests 112 are received by a driver 114, which generates block I/O operations 116 based on the access requests 112. The block I/O operations 116 include read block I/O operations to read data blocks of the primary data store 108, and write block I/O operations 118 to write data blocks to the primary data store 108.

The driver 114 is an entity that manages access of the primary data store 108. In some examples, the driver 114 may be part of a hypervisor that creates and manages VMs. In other examples, the driver 114 may be part of an OS of the computer system 102.

The replication controller 106 detects write block I/O operations 118 provided by the driver 114. The replication controller 106 replicates the write block I/O operations 118 to the recovery storage system 104.

In accordance with some examples of the present disclosure, the replication controller 106 includes an attack detector 120 that is able to detect when an attack that involves encryption of data is occurring. The attack detector 120 can be implemented using hardware processing circuitry of the replication controller 106, or machine-readable instructions executed by the replication controller 106. In other examples, the attack detector 120 can be separate from the replication controller 106.

The attack detector 120 is able to detect partial encryption of files, such as performed by an intermittent ransomware attack, or full encryption of files. The attack detector 120 can perform an encryption attack detection in real time as the write block I/O operations 118 are processed by the replication controller 106 for replication to the recovery storage system 104. Performing the encryption attack detection in real time refers to performing the encryption attack detection as I/O operations are being transferred to a target (in this case transferring the write block I/O operations 118 to the recovery storage system 104 as part of replication of the write block I/O operations 118). Real time detection of an encryption attack detection differs from an offline encryption attack detection, in which data stored some time ago is analyzed for determining whether the stored data has been encrypted.

The attack detector 120 includes a write I/O analyzer 122 and a file type comparator 126. The write I/O analyzer 122 and the file type comparator 126 can be implemented using hardware processing circuitry of the attack detector 120, or with machine-readable instructions executed by the replication controller 106.

The write block I/O operations include metadata write block I/O operations that write metadata associated with files, file write block I/O operations that write content of data blocks of target files, and write block I/O operations that are not recognized as either metadata write block I/O operations or file write block I/O operations. The write I/O analyzer 122 analyzes the write block I/O operations to identify the type of each write block I/O operation.

In some examples, the metadata associated with a file includes a file record, such as a file record provided by the New Technology File System (NTFS) from Microsoft. In other examples, other types of file systems can be used that manage access of files, such as a Fourth Extended (EXT4) file system associated with a Linux operating system, an Apple file system, or another type of file system.

Generally, a file system includes metadata that represents a file. The metadata contains attributes about the file, where the attributes can include any or some combination of the following: a name of the file, a timestamp indicating a time at which the file was created or modified, and storage location information identifying a storage location (e.g., in the primary data store 108) where data of the file is located. In some examples, the storage location information includes a data offset. A “data offset” can identify a storage location of data relative to a reference storage location in a storage system (e.g., the data offset can be added to the reference storage location to determine the actual storage location of the data in the storage system).

As shown in FIG. 1, the primary data store 108 contains files 130 that are part of a file system. The primary data store 108 further contains metadata in a metadata repository 132. In examples where NTFS is used, the metadata repository 132 is in the form of a master file table (MFT). In other examples where a different type of file system is used, the metadata repository 132 can be implemented using other data structures.

In some examples, the write I/O analyzer 122 adds entries to a metadata I/O table 140 for respective metadata write block I/O operations, and the write I/O analyzer 122 adds entries to a file I/O table 142 for respective file write block I/O operations as well as unrecognized write block I/O operations. An “unrecognized” write block I/O operation is a write block I/O operation that is not recognized as either a metadata write block I/O operations or a file write block I/O operation of a recognized file type.

The metadata I/O table 140 and the file I/O table 142 are stored in a memory 144 of the computer system 102. Although referred to as tables, it is noted that the metadata I/O table 140 and the file I/O table 142 can be implemented using other types of data structures, such as text files, trees, and so forth.

In an example, the metadata I/O table 140 includes a File Name column and a Data Offset column. The File Name column includes names of respective files detected in the metadata of metadata write block I/O operations. As used here, “metadata of a metadata write block I/O operation” can refer to metadata that is included as part of the metadata write block I/O operation. In the example shown, the metadata I/O table 140 includes entries 146-1, 146-2, 146-3, and 146-4 containing the following respective file names are: 1.DOCX, 2.PPTX, 3.PPTX, and 4.PDF. Each of the foregoing file names has an extension indicating the file type. For example, the .DOCX extension indicates a Word file, the .PPTX extension indicates a PowerPoint file, and the .PDF extension indicates an Acrobat file. In further examples, a .JPG extension indicates a JPEG file, an .MPG extension indicates an MPEG file, and so forth.

The Data Offset column of the metadata I/O table 140 includes data offsets at which data of the respective files are located. The file name and the data offset in each entry of the metadata I/O table 140 are extracted from the metadata of a respective metadata write block I/O operation. The entry 146-1 specifies that the file having the file name 1.DOCX is stored at data offset 600, the entry 146-2 specifies that the file having the file name 2.PPTX is stored at data offset 800, the entry 146-3 specifies that the file having the file name 3.PPTX is stored at data offset 100, and the entry 146-4 specifies that the file having the file name 4.PDF is stored at data offset 200.

In the example shown, the file I/O table 142 includes a Data Offset column and a Header Type column. The Data Offset column identifies data offsets associated with respective file write block I/O operations. A file write block I/O operation performs a write of a data block of a file that is located at a respective data offset. The Header Type column includes file type information derived from a header of a file write block I/O operation. The header of the file write block I/O operation can include a signature that indicates a file type. Different signatures in headers of file write block I/O operations indicate different file types, such as DOCX, PPTX, PDF, JPG, MPG, and so forth.

In an example, an entry 148-1 of the file I/O table 142 specifies that a file at data offset 800 is of the PPTX type, an entry 148-2 specifies that a file at data offset 500 is of the JPG type, an entry 148-3 of the file I/O table 142 specifies that a file at data offset 100 is of the “unrecognized” file type, and an entry 148-4 of the file I/O table 142 specifies that a file at data offset 220 is of the unrecognized” file type. The “unrecognized” file type included in the Header Type column of an entry of the file I/O table 142 indicates that the write I/O analyzer 122 was unable to determine the file type from the header of a respective file write block I/O operation.

Although the metadata I/O table 140 and the file I/O table 142 depicts columns in specific orders, in other examples, the columns can be in different orders. Further, in other examples, the metadata I/O table 140 and the file I/O table 142 may include alternative or additional columns. In further examples, each of the metadata I/O table 140 and the file I/O table 142 can include a different quantity of entries.

The file type comparator 126 compares entries of the metadata I/O table 140 and the file I/O table 142. The file type comparator 126 compares data offsets in the entries of the metadata I/O table 140 to data offsets in the entries of the file I/O table 142, to determine whether there are matching data offsets. For example, the entry 146-2 of the metadata I/O table 140 has a data offset 800, which matches the data offset 800 in the entry 148-1 of the file I/O table 142. Based on identifying the matching data offsets, the file type comparator 126 compares a file type indicated by the File Name column of the entry 146-2 to the file type indicated by the Header Type column in the entry 148-1. The file type comparator 126 is able to determine that the PPTX file type indicated by the entry 146-2 matches the PPTX file type indicated by the entry 148-1. The matching file types of the compared entries 146-2 and 148-1 of the metadata I/O table 140 and the file I/O table 142, respectively, indicate that the file at data offset 800 has not been subjected to encryption.

The file type comparator 126 also detects that the entry 146-3 of the metadata I/O table 140 has a data offset 100 that matches the data offset 100 in the entry 148-3 of the file I/O table 142. The file type comparator 126 compares the file type indicated by the File Name column of the entry 146-3 to the file type indicated by the Header Type column of the entry 148-3 of the file I/O table 142. The file type comparator 126 detects a mismatch between the PPTX file type indicated by the entry 146-3 and the “unrecognized” file type indicated by the entry 148-3.

The mismatch may be an indication of an encryption attack. In response to the mismatch, the file type comparator 126 issues an attack alert 150 to a remediation engine 152. The attack alert 150 can be in the form of a signal, a message, an information element, or any other indicator. The attack alert 150 indicates which file has been encrypted (e.g., the attack alert 150 can include the data offset 100).

The remediation engine 152 receiving the attack alert 150 may be part of the computer system 102, or the remediation engine 152 may be outside the computer system 102. The remediation engine 152 can apply one or more remediation actions in response to the attack alert 150.

In some examples, the remediation engine 152 can track a number of mismatches associated with any given data offset. For example, for the data offset 100, the remediation engine 152 can track (using a counter) how many instances of mismatches have occurred for the file at data offset 100. If the count of mismatches indicated by the counter exceeds a threshold (e.g., 1 or greater than 1), the remediation engine 152 can make a determination that an encryption attack is likely occurring with respect to the file at data offset 100. In response, the remediation engine 152 can initiate the one or more remediation actions. Examples of remediation actions can include any or some combination of the following: sending a notification to a target entity (e.g., a human administrator, a program, or a machine), disabling the computer system 102 by shutting down the computer system 102 or disabling programs of the computer system 102), disabling a network connectivity of the computer system 102, or any other type of remediation action. Thus, the attack detector 120 can detect other types of malware attacks aside from unauthorized encryption attacks.

In other examples, the mismatch may be an indication of another anomaly relating to data. For example, malware or another entity may have deliberately or inadvertently created a file name with an incorrect extension. Moreover, instead of or in addition to the attack detector 120, a data integrity and validation engine that includes a write I/O analyzer and a file type comparator (similar to the write I/O analyzer 122 and the file type comparator 126) can be used to detect other anomalies relating to data. The data integrity and validation engine can issue an anomaly alert in response to detecting a mismatch of file types in metadata and file write block I/O operations.

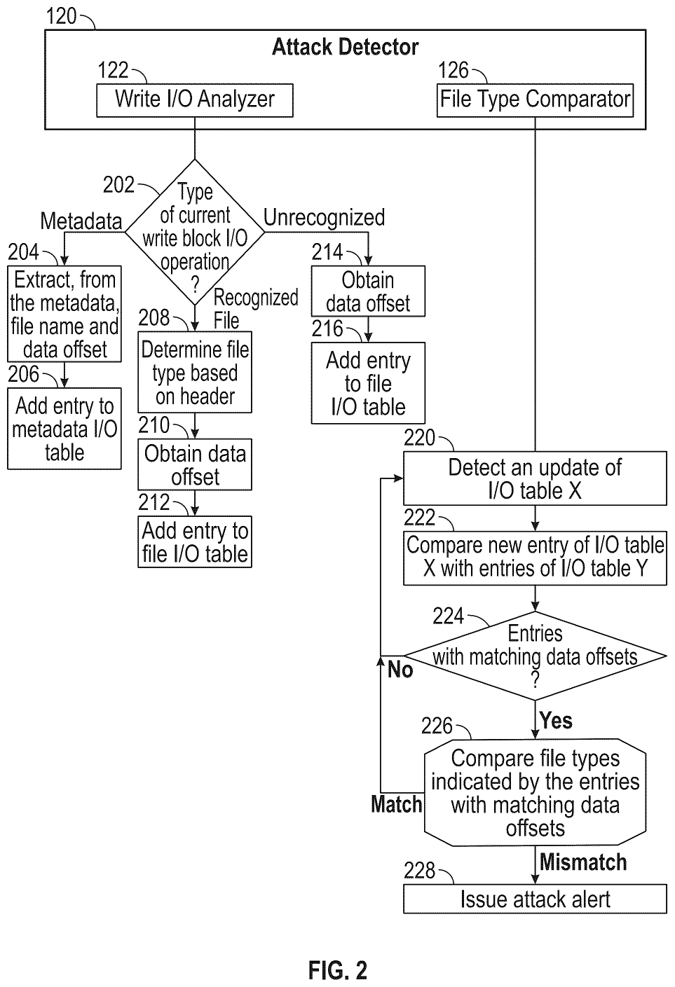

FIG. 2 is a message flow diagram of a process performed by the attack detector 120, in accordance with some examples of the present disclosure. The attack detector 120 monitors a stream of write block I/O operations. The write I/O analyzer 122 in the attack detector 120 analyzes each write block I/O operation as the write block I/O operation is received. This write block I/O operation is referred to as a “current” write block I/O operation. The process starts at 202 for each write block I/O operation received.

The write I/O analyzer 122 determines (at 202) a type of the current write block I/O operation, which can be one of a metadata write block I/O operation, a file write block I/O operation of a recognized file type, or an unrecognized write block I/O operation.

The detection of a metadata write block I/O operation is based on a header of the metadata write block I/O operation. In some examples, the metadata write block I/O operation is indicated by a metadata special header (or “metadata prefix”) of a write block I/O operation. For the NTFS, the metadata write block I/O operation is indicated by a string “FILE,” which is an example of the metadata prefix. In other examples, the metadata write block I/O operation is indicated with other metadata prefixes. A write block I/O operation without the metadata prefix is not a metadata write block I/O operation.

The detection of a file write block I/O operation of a recognized file type is based on a recognized signature present in a header of a write block I/O operation. Note that the header of the file write block I/O operation does not contain the metadata prefix that indicates a metadata write block I/O operation. Rather, the header of the file write block I/O operation may contain a signature to identify the file type of a file that is the subject of the file write block I/O operation. For example, a file write block I/O operation containing the signature “PK . . . ” in its header (where “ . . . ” indicates that further characters follow “PK”) performs a write of a DOCX file. As another example, a file write block I/O operation containing the signature “% PDF . . . ” in its header performs a write of PDF file. Other signatures in the headers of other file write block I/O operations indicate writes of other recognized file types.

It is also possible that a header of a write block I/O operation does not contain either the metadata prefix for a metadata write block I/O operation or a recognized signature of a file block I/O operation. In this case, the write block I/O operation is an unrecognized write block I/O operation, which is a file write block I/O operation of an unrecognized file type. An example of an unrecognized write block I/O operation is a write block I/O operation that writes an encrypted data block.

Based on detecting that the current write block I/O operation is a metadata write block I/O operation, the write I/O analyzer 122 extracts (at 204), from the metadata of the metadata write block I/O operation, the file name of a file represented by the metadata, and a data offset of the file. The write I/O analyzer 122 adds (at 206) an entry to the metadata I/O table 140, where the added entry correlates the file name to the data offset extracted from the metadata. The file name in the added entry contains an extension (e.g., DOCX extension, PPTX extension, PDF extension, etc.) indicating a respective file type.

In some cases, it is possible that the metadata of a metadata write block I/O operation does not contain a file name with a recognized extension. In such cases, an entry would not be added by the write I/O analyzer 122 to the metadata I/O table 140. Effectively, no further analysis is performed for information in a metadata write block I/O operation without a recognized file type extension.

Based on detecting that the current write block I/O operation is a file write block I/O operation of a recognized file type, the write I/O analyzer 122 determines (at 208) the file type based on the signature in the header of the file write block I/O operation. The write I/O analyzer 122 also obtains (at 210) the data offset associated with the file write block I/O operation. Each file write block I/O operation targets a respective data offset.

The write I/O analyzer 122 adds (at 212) an entry to the file I/O table 142, where the added entry correlates the determined file type (in the Header Type column of the added entry) to the data offset of the file that is the target of the file write block I/O operation.

Based on detecting that the current write block I/O operation is an unrecognized file write block I/O operation (e.g., the header of the current write block I/O operation does not contain a recognized signature), the write I/O analyzer 122 obtains (at 214) the data offset associated with the unrecognized write block I/O operation. The write I/O analyzer 122 adds (at 216) an entry to the file I/O table 142, where the added entry correlates the “unrecognized” file type (in the Header Type column of the added entry) to the data offset of the unrecognized write block I/O operation.

The file type comparator 126 starts at 220 for each detected update of the metadata I/O table 140 or the file I/O table 142. The file type comparator 126 detects (at 220) an update of I/O table X, which is either the metadata I/O table 140 or the file I/O table 142. Note that updates of the metadata I/O table 140 and the file I/O table 142 may not be synchronized, which may be caused by a write of a data block of a file and a corresponding write of the metadata for the file to the primary data store 108 occurring at different times (e.g., separated by a few seconds or some other time interval). For example, the write of the metadata for the file may occur before the write of the data block of the file, or vice versa, which would cause the entries for these writes to be added to the metadata I/O table 140 and the file I/O table 142 at different times. As a result, the file type comparator 126 may not find matching data offsets in corresponding entries of the metadata I/O table 140 and the file I/O table 142 when a new entry is added to one of the metadata I/O table 140 or the file I/O table 142. However, at a later time after the corresponding new entry is added to the other one of the metadata I/O table 140 or the file I/O table 142, the file type comparator 126 may find matching data offsets in corresponding entries of the metadata I/O table 140 and the file I/O table 142.

The file type comparator 126 may detect the update of I/O table X based on receiving a notification of the update, such as from the write I/O analyzer 122. In response to detecting the update (which includes the addition of a new entry to I/O table X), the file type comparator 126 compares (at 222) the new entry added to I/O table X to entries of I/O table Y. I/O table Y is the other one of the metadata I/O table 140 and the file I/O table 142. More specifically, if I/O table X is the metadata I/O table 140, the file type comparator 126 compares the new entry added to the metadata I/O table 140 to entries of the file I/O table 142. On the other hand, if I/O table X is the file I/O table 142, the file type comparator 126 compares the new entry added to the file I/O table 142 to entries of the metadata I/O table 140.

The file type comparator 126 determines (at 224) whether there are entries from the metadata I/O table 140 and the file I/O table 142 with matching data offsets. If not, the file type comparator 126 returns to wait for another update (at 220). However, if there are entries from the metadata I/O table 140 and the file I/O table 142 with matching data offsets, the file type comparator 126 compares (at 226) the file types indicated by the entries with the matching data offsets. If the file types match, the file type comparator 126 returns to wait for another update. However, if the file types do not match, the file type comparator 126 issues (at 228) an attack alert (e.g., 150 in FIG. 1), which may be sent to a remediation engine (e.g., 152 in FIG. 1). More generally, the file type comparator 126 can issue an anomaly alert based on detecting mismatching file types in the metadata I/O table 140 and the file I/O table 142.

In some examples, to reduce consumption of the memory 144, entries of the metadata I/O table 140 and the file I/O table 142 may be evicted if one or more criteria are satisfied. For example, an entry can be removed from the metadata I/O table 140 or the file I/O table 142 if the entry has been present in the metadata I/O table 140 or the file I/O table 142 for greater than a threshold time duration. As another example, to provide space in the metadata I/O table 140 or the file I/O table 142 to accommodate a new entry, an existing entry in the metadata I/O table 140 or the file I/O table 142 can be removed according to a least recently used (LRU) criterion; i.e., the entry evicted is the entry that was least recently used in the respective I/O table.

In some examples, the Header Type column of the file I/O table 142 contains just information of a determined file type (a recognized file type such as DOCX, PPTX, PDF, etc., or an unrecognized file type). In other examples, instead of determining the file type as write block I/O operations are processed, the first 256 bytes (or some other segment) of a non-metadata write block I/O operation can be stored in the Header Type column. Then, if matching offsets are found in corresponding entries of the metadata I/O table 140 and the file I/O table 142, the content of the Header Type column can be parsed to determine the file type. These latter examples may reduce processing burden since a specific file type determination would not have to be performed until matching data offsets are detected between the metadata I/O table 140 and the file I/O table 142. However, such latter examples may consume more memory space since more information is stored in the Header Type column.

Table 1 below lists 8 example write block I/O operations. The “Data Offset” column of Table 1 indicates the data offset that is the target of the write block I/O operation. The “Parsed Information” column of Table 1 includes information parsed for the write block I/O operation. The “Interpretation of Information” column of Table 1 specifies what the parsed information indicates.

TABLE 1

| | Data | Parsed | Interpretation |
|---|---|---|---|
| | Offset | Information | of Information |
| 1 | 20 | FILE . . . 1.PDF . . . | File record |
| | | 500 . . . | File name: 1.PDF |
| | | | Data offset: 500 |
| 2 | 24 | FILE . . . 2.DOCX . . . | File record |
| | | 1000 . . . | File name: 2.DOCX |
| | | | Data offset: 1000 |
| 3 | 600 | PK . . . | DOCX signature |
| 4 | 1000 | PK . . . | DOCX signature |
| 5 | 500 | % PDF . . . | PDF signature |
| 6 | 30 | FILE . . . 3.DOCX . . . | File record |
| | | 600 . . . | File name: 3.DOCX |
| | | | Data offset: 600 |
| 7 | 700 | ???????????????????????????? | Unrecognized header |
| 8 | 700 | FILE . . . 4.PDF . . . | File record |
| | | 700 . . . | File name: 4.PDF |
| | | | Data offset: 700 |

Entry 1 of Table 1 is a metadata write block I/O operation to data offset 20 (this example data offset is part of the primary data store 108 containing the metadata repository 132 of FIG. 1). The header of the metadata write block I/O operation represented by Entry 1 has the metadata prefix “FILE,” which indicates a write of a file record (an example of metadata). The metadata (file record) of the metadata write block I/O operation represented by Entry 1 contains the file name 1.PDF, and the metadata specifies that the data offset of this file (1.PDF) is 500.

Entry 2 of Table 1 is a metadata write block I/O operation to data offset 24 (this example data offset is part of the primary data store 108 containing the metadata repository 132 of FIG. 1). The header of the metadata write block I/O operation represented by Entry 2 has the metadata prefix “FILE,” which indicates a write of a file record. The metadata (file record) of the metadata write block I/O operation represented by Entry 2 contains the file name 2.DOCX, and the metadata specifies that the data offset of this file (2.DOCX) is 1000.

Entry 3 of Table 1 is a file write block I/O operation to data offset 600. The header of the file write block I/O operation represented by Entry 3 has the signature “PK . . . ” that indicates the DOCX file type.

Entry 4 of Table 1 is a file write block I/O operation to data offset 1000. The header of the file write block I/O operation represented by Entry 4 has the signature “PK . . . ” that indicates the DOCX file type.

Entry 5 of Table 1 is a file write block I/O operation to data offset 500. The header of the file write block I/O operation represented by Entry 3 has the signature “% PDF . . . ” that indicates the PDF file type.

Entry 6 of Table 1 is a metadata write block I/O operation to data offset 30 (this example data offset is part of the primary data store 108 containing the metadata repository 132 of FIG. 1). The header of the metadata write block I/O operation represented by Entry 6 has the metadata prefix “FILE,” which indicates a write of a file record. The metadata (file record) of the metadata write block I/O operation represented by Entry 6 contains the file name 3.DOCX, and the metadata specifies that the data offset of this file (3.DOCX) is 600.

Entry 7 of Table 1 is an unrecognized write block I/O operation to data offset 700. The header of the unrecognized write block I/O operation does not contain the metadata prefix or a recognized file type signature.

Entry 8 of Table 1 is a file write block I/O operation to data offset 700. The header of the file write block I/O operation represented by Entry 8 has the signature “% PDF . . . ” that indicates the PDF file type.

In examples where metadata for files includes file records of an NTFS, a file record has a size of 1 kilobyte (KB). Further, with an NTFS, file records are written to an MFT, which is an example of the metadata repository 132 of FIG. 1. Further, write I/O operations to the MFT are 4-KB aligned, which means that a write to the MFT is a write of a 4-KB segment. Since each file record has a 1-KB size, that means that a write of the 4-KB segment to the MFT may include up to four file records. When the write I/O analyzer 122 detects the “FILE” metadata prefix of a first file record at the beginning of the 4-KB segment, the write I/O analyzer 122 can proceed to parse the metadata in the three other successive file records in the 4-KB segment to extract attributes from each of the file records in the 4-KB segment.

As the write block I/O operations are received, the write I/O analyzer 122 (FIG. 1) adds respective entries to the metadata I/O table 140 and the file I/O table 142. After the 8 write block I/O operations have been processed by the write I/O analyzer 122, the entries of the metadata I/O table 140 are represented by Table 2 below, and the entries of the file I/O table 142 are represented by Table 3 below.

TABLE 2

| File Name | Data offset |
|---|---|
| 1.PDF | 500 |
| 2.DOCX | 1000 |
| 3.DOCX | 600 |
| 4.PDF | 700 |

TABLE 3

| Data Offset | Header Type |
|---|---|
| 600 | DOCX header |
| 1000 | DOCX header |
| 500 | PDF header |
| 700 | Unrecognized |

In the above example, the data offset (500) in the first entry of Table 2 matches the data offset (500) in the third entry of Table 3. The file type comparator 126 can determine from these entries that the file type (PDF) indicated by the File Name column of the first entry of Table 2 matches the file type (PDF) indicated by the Header Type column of the third entry of Table 3.

Also, the data offset (700) in the fourth entry of Table 2 matches the data offset (700) in the fourth entry of Table 3. The file type comparator 126 can determine from these entries that the file type (PDF) indicated by the File Name column of the fourth entry of Table 2 does not match the unrecognized file type indicated by the Header Type column of the fourth entry of Table 3. The file type comparator 126 can issue an attack alert in response to the mismatch of file types.

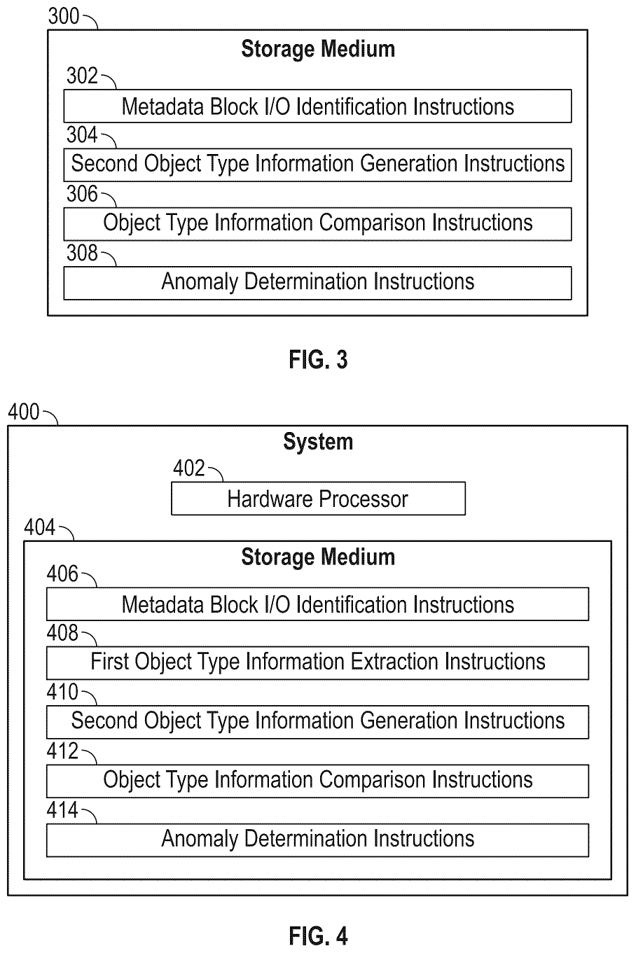

FIG. 3 is a block diagram of a non-transitory machine-readable or computer-readable storage medium 300 storing machine-readable instructions that upon execution cause a system to perform various tasks. The system may be the computer system 102 of FIG. 1, for example. The machine-readable instructions may be part of the attack detector 120 or any other detector of anomalies relating to data.

The machine-readable instructions include metadata block I/O identification instructions 302 to identify a first block I/O operation relating to writing metadata for a data object, the metadata of the first block I/O operation including first object type information. For example, the metadata can include an object name of an object, where the object name includes a type extension indicating a type of the object. If the object is a file, then the object name is a file name including a file type extension.

The machine-readable instructions include second object type information generation instructions 304 to generate, based on a header of a second block I/O operation relating to writing object content to a target data object (e.g., file content to a target file), second object type information relating to an object type of the target data object. The header of the second block I/O operation can include a signature indicating the second object type, for example. Different object types of data objects are associated with different signatures.

The machine-readable instructions include object type information comparison instructions 306 to compare the first object type information in the metadata of the first block I/O operation to the second object type information.

The machine-readable instructions include anomaly determination instructions 308 to, based on the comparing, determine whether an anomaly relating to data has occurred. If the first object type information and the second object type information do not match, then the machine-readable instructions can indicate that an anomaly relating to data has occurred. The anomaly relating to data can include a data encryption attack, another type of malware attack, an inadvertent error, or any other anomaly.

In some examples, the identifying of the first block I/O operation relating to writing the metadata includes detecting a metadata prefix in a header of the first block I/O operation.

In some examples, the generated second object type information indicates an unrecognized object type responsive to the second block I/O operation not including any signature relating to a recognized object type. A “recognized object type” (such as a recognized file type) is an object type indicated by predefined information, such as a list of object types that are known to exist or that are permitted to be used in a computer system or other computing environment.

In some examples, the machine-readable instructions can extract, from the metadata of the first block I/O operation, a first data offset relating to where the data object associated with the metadata is stored in a storage system. The machine-readable instructions can determine a second data offset relating to where the target data object is written by the second block I/O operation in the storage system. The comparing of the first object type information to the second object type information is responsive to the first data offset matching the second data offset.

In some examples, the machine-readable instructions can add the first data offset and the first object type information to an entry of a first data structure, and add the second data offset and the second object type information to an entry of a second data structure. The comparing is based on identifying the entries of the first data structure and the second data structure with the matching first and second data offsets.

In some examples, in response to detecting an update of one of the first data structure and the second data structure, the machine-readable instructions can compare entries of the first data structure and the second data structure to identify any matching data offsets. Based on identifying a first entry of the first data structure and a second entry of the second data structure with matching data offsets, the machine-readable instructions can compare object type information in the first entry to object type information in the second entry.

In some examples, the machine-readable instructions can indicate occurrence of the anomaly relating to data responsive to the object type information in the first entry not matching the object type information in the second entry.

In some examples, the machine-readable instructions can remove (evict) an entry from the first data structure or the second data structure based on an age of the entry.

In some examples, the machine-readable instructions can remove (evict) an entry from the first data structure or the second data structure according to an LRU criterion.

In some examples, the first block I/O operation is a metadata block I/O operation, and the second block I/O operation is an object block I/O operation. The machine-readable instructions can track a count of occurrences of mismatches of object types in further metadata and file block I/O operations, compare the count to a threshold, and based on the count exceeding the threshold, indicate occurrence of the anomaly relating to data.

FIG. 4 is a block diagram of a system 400 according to some examples of the present disclosure. An example of the system 400 is the computer system 102 of FIG. 1.

The system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The system 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include metadata block I/O identification instructions 406 to identify a metadata block I/O operation relating to writing metadata for a data object. The identification of the metadata block I/O operation can be based on a metadata prefix in a header of the metadata block I/O operation.

The machine-readable instructions in the storage medium 404 include first object type information extraction instructions 408 to extract, from the metadata of the metadata block I/O operation, first object type information. The metadata may include an object name that includes an extension indicating the first object type.

The machine-readable instructions in the storage medium 404 include second object type information generation instructions 410 to generate, based on a header of an object block I/O operation relating to writing object content to a target data object, second object type information relating to an object type of the target data object. The second object type information can indicate a recognized object type or an unrecognized object type.

The machine-readable instructions in the storage medium 404 include object type information comparison instructions 412 to compare the first object type information in the metadata of the metadata block I/O operation to the second object type information.

The machine-readable instructions in the storage medium 404 include anomaly determination instructions 414 to, based on the comparing, determine whether an anomaly relating to data has occurred.

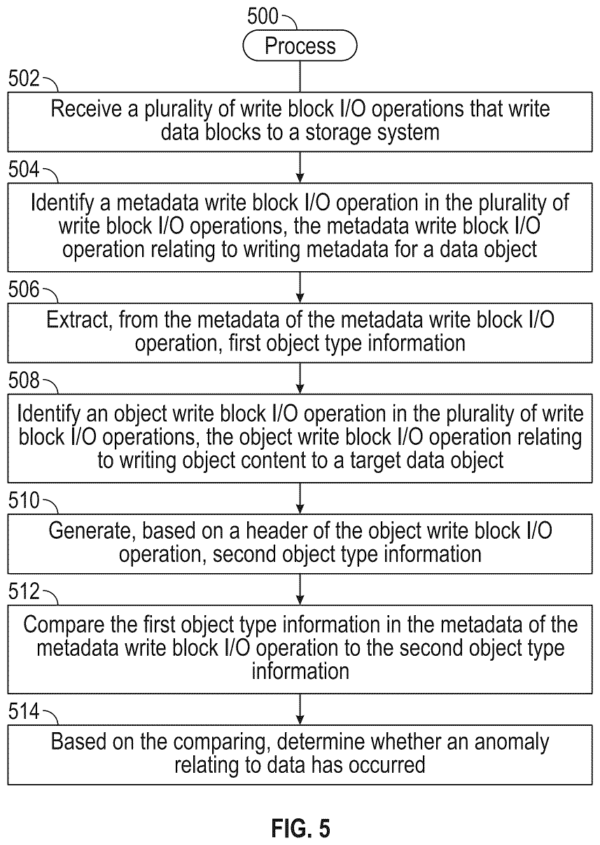

FIG. 5 is a flow diagram of a process 500 according to some examples. The process 500 may be performed by the attack detector 120 of FIG. 1, or any other type of detector.

The process 500 includes receiving (at 502) a plurality of write block I/O operations that write data blocks to a storage system. For example, the plurality of write block I/O operations are detected by the replication controller 106, which replicates the plurality of write block I/O operations to the recovery storage system 104 of FIG. 1.

The process 500 includes identifying (at 504) a metadata write block I/O operation in the plurality of write block I/O operations, the metadata write block I/O operation relating to writing metadata for a data object.

The process 500 includes extracting (at 506), from the metadata of the metadata write block I/O operation, first object type information. The first object type information can include an object type extension in an object name included in the metadata.

The process 500 includes identifying (at 508) an object write block I/O operation in the plurality of write block I/O operations, the object write block I/O operation relating to writing object content to a target data object. The object write block I/O operation can be an object write block I/O operation of a recognized object type, or an object write block I/O operation of an unrecognized object type.

The process 500 includes generating (at 510), based on a header of the object write block I/O operation, second object type information. The second object type information can include a recognized object type, or an indication (e.g., “unrecognized”) that the object type is unrecognized.

The process 500 includes comparing (at 512) the first object type information in the metadata of the metadata write block I/O operation to the second object type information. Based on the comparing, the process 500 determines (at 514) whether an anomaly relating to data has occurred.

As used here, a “storage system” can be implemented using one or more storage devices, such as disk-based storage devices, solid state drives, or other types of storage devices.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
identify a first block input/output (I/O) operation relating to writing metadata for a data object, the metadata of the first block I/O operation comprising first object type information, and
generate, based on a header of a second block I/O operation relating to writing object content to a target data object, second object type information relating to an object type of the target data object;
compare the first object type information in the metadata of the first block I/O operation to the second object type information; and
based on the comparing, determine whether an anomaly relating to data has occurred.

2. The non-transitory machine-readable storage medium of claim 1, wherein the identifying of the first block I/O operation relating to writing the metadata comprises detecting a metadata prefix in a header of the first block I/O operation.

3. The non-transitory machine-readable storage medium of claim 1, wherein the instructions upon execution cause the system to:
detect a signature relating to the object type of the target data object in the header of the second block I/O operation,
wherein the generated second object type information is based on the signature.

4. The non-transitory machine-readable storage medium of claim 3, wherein different object types of data objects are associated with different signatures.

5. The non-transitory machine-readable storage medium of claim 1, wherein the generated second object type information indicates an unrecognized object type responsive to the second block I/O operation not including any signature relating to a recognized object type.

6. The non-transitory machine-readable storage medium of claim 1, wherein the target data object includes a file, and the metadata of the first block I/O operation is for a file.

7. The non-transitory machine-readable storage medium of claim 6, wherein the first block I/O operation relates to writing the metadata of a file record in a file system.

8. The non-transitory machine-readable storage medium of claim 1, wherein the instructions upon execution cause the system to:
extract, from the metadata of the first block I/O operation, a first data offset relating to where the data object associated with the metadata is stored in a storage system; and
determine a second data offset relating to where the target data object is written by the second block I/O operation in the storage system,
wherein the comparing of the first object type information to the second object type information is responsive to the first data offset matching the second data offset.

9. The non-transitory machine-readable storage medium of claim 8, wherein the instructions upon execution cause the system to:
add the first data offset and the first object type information to an entry of a first data structure; and
add the second data offset and the second object type information to an entry of a second data structure,
wherein the comparing is based on identifying the entries of the first data structure and the second data structure with the matching first and second data offsets.

10. The non-transitory machine-readable storage medium of claim 9, wherein the instructions upon execution cause the system to:
in response to detecting an update of one of the first data structure and the second data structure, compare entries of the first data structure and the second data structure to identify any matching data offsets; and
based on identifying a first entry of the first data structure and a second entry of the second data structure with matching data offsets, compare object type information in the first entry to object type information in the second entry.

11. The non-transitory machine-readable storage medium of claim 10, wherein the instructions upon execution cause the system to:
indicate occurrence of the anomaly relating to data responsive to the object type information in the first entry not matching the object type information in the second entry.

12. The non-transitory machine-readable storage medium of claim 9, wherein the instructions upon execution cause the system to:
remove an entry from the first data structure or the second data structure based on an age of the entry.

13. The non-transitory machine-readable storage medium of claim 9, wherein the instructions upon execution cause the system to:
remove an entry from the first data structure or the second data structure according to a least recently used criterion.

14. The non-transitory machine-readable storage medium of claim 8, wherein the first block I/O operation is a metadata block I/O operation, and the second block I/O operation is an object block I/O operation, and wherein the instructions upon execution cause the system to:
track a count of occurrences of mismatches of object types in further metadata and file block I/O operations;
compare the count to a threshold; and
based on the count exceeding the threshold, indicate occurrence of the anomaly relating to data.

15. The non-transitory machine-readable storage medium of claim 1, wherein the anomaly relating to data comprises an unauthorized encryption of data.

16. A system comprising:
a hardware processor; and
a non-transitory machine-readable storage medium storing instructions executable on the hardware processor to:
identify a metadata block input/output (I/O) operation relating to writing metadata for a data object;
extract, from the metadata of the metadata block I/O operation, first object type information;
generate, based on a header of an object block I/O operation relating to writing object content to a target data object, second object type information relating to an object type of the target data object;
compare the first object type information in the metadata of the metadata block I/O operation to the second object type information; and
based on the comparing, determine whether an anomaly relating to data has occurred.

17. The system of claim 16, wherein the second object type information is generated based on a signature of a recognized object type in the header of the object block I/O operation.

18. The system of claim 16, wherein the second object type information indicates an unrecognized object type based on the header of the object block I/O operation not including any signature of a recognized object type.

19. A method comprising:
receiving a plurality of write block input/output (I/O) operations that write data blocks to a storage system;
identifying, by a system comprising a hardware processor, a metadata write block I/O operation in the plurality of write block I/O operations, the metadata write block I/O operation relating to writing metadata for a data object;
extracting, by the system from the metadata of the metadata write block I/O operation, first object type information;
identifying, by the system, an object write block I/O operation in the plurality of write block I/O operations, the object write block I/O operation relating to writing object content to a target data object;
generating, by the system based on a header of the object write block I/O operation, second object type information;
comparing, by the system, the first object type information in the metadata of the metadata write block I/O operation to the second object type information; and
based on the comparing, determining, by the system, whether an anomaly relating to data has occurred.

20. The method of claim 19, comprising:
replicating, by the system, the plurality of write block I/O operations to a recovery storage system,
wherein the identifying of the metadata write block I/O operation, the extracting of the first object type information, the identifying of the object write block I/O operation, the generating of the second object type information, the comparing, and the determining are performed in conjunction with the replicating.
